(19) United States
(12) Patent Application Publication
(10) Pub. No.: US 2026/0194501 A1
(43) Pub. Date: Jul. 9, 2026

(54) DETECTOR FOR LIQUID CHROMATOGRAPHY

(71) Applicant: TOSOH CORPORATION, Shunan-shi, Yamaguchi (JP)

(72) Inventor: Masafumi HORIGA, Ayase-shi (JP)

(73) Assignee: TOSOH CORPORATION, Shunan-shi, Yamaguchi (JP)

(21) Appl. No.: 19/129,869

(22) PCT Filed: Nov. 21, 2023
(86) PCT No.: PCT/JP2023/041798

§ 371 Date: May 14, 2025

(30) Foreign Application Priority Data
Nov. 22, 2022 (JP) 2022-186846

(51) Int. Cl. G01N 30/74; G01N 30/02

(52) U.S. Cl. CPC G01N 30/74; G01N 2030/027

(57) ABSTRACT

An object of the present disclosure is to provide a detector for liquid chromatography that reduces noise generated when the air pressure in the environment where the detector for liquid chromatography is installed varies. The detector for liquid chromatography includes a housing, a detection cell disposed inside the housing, an inlet pipe for introducing a fluid into the detection cell, an inlet-side heat exchanger disposed inside the housing and configured to exchange heat with a portion of the inlet pipe, and a filler disposed around a portion of the inlet pipe from the inlet-side heat exchanger to the detection cell, the portion being disposed inside the housing.

### FIELD

The present disclosure relates to a detector for liquid chromatography that detects the properties of a fluid in a liquid chromatograph and components contained in the fluid.

### BACKGROUND

Liquid chromatography is a method in which a sample is injected into a fluid field in a mobile phase pressurized and delivered by a liquid delivery pump, the sample is separated in an analytical column, and then the components in the sample are quantitatively and qualitatively analyzed in a detector. The detector to be used varies, depending on the type of mobile phase, the properties of the sample, and the separation principle, and one or more detectors are selected according to the purpose of the analysis.

The flow path of the detector includes a detection cell, a pipe for causing an eluate from a column to flow into the detection cell, and a pipe for discharging the eluate from the detection cell. Small temperature variations of the liquid cause the physical parameters of the liquid to vary at detection, reducing the accuracy and reproducibility of the analysis. Thus, techniques are generally used to reduce temperature variations in the detector, when the temperature outside the detector varies, by controlling the temperature of the liquid flowing into the detection cell with a heat exchanger, covering the detector housing with a thermal insulator, or controlling the temperature of the detector housing.

In a liquid chromatograph, an organic solvent may be used as a mobile phase or a solvent for dissolving a sample. When operating a liquid chromatograph that uses an organic solvent indoors, laws such as the Industrial Safety and Health Law in Japan are followed, and a local exhaust ventilation system or draft booth that uses the action of pressure to exhaust organic solvent vapors outdoors is commonly used to prevent exposure of the liquid chromatograph operator to the organic solvent and organic solvent poisoning. A room that is made to have negative pressure by using a local exhaust ventilation system or draft booth has a lower air pressure than the outside environment. The air pressure in the room at this time is generally about 10 to 150 Pa lower than atmospheric pressure, depending on the performance of the local exhaust ventilation system or draft booth used and the structure of the room.

When the door of a room where a local exhaust ventilation system or draft booth is used is temporarily opened, the air pressure in the room rises rapidly to atmospheric pressure. If the door of the room is then closed, the air pressure returns to a low state, so that the air pressure in the room drops rapidly. At this time, a detector installed in the room where the local exhaust ventilation system or draft booth is used is also subjected to the same action of pressure. Thus, the gas phase in the detector internal space experiences adiabatic compression and expansion due to the flow of air outside the detector in and out, causing temperature variations in the detector internal space, or variations in air pressure in the installation environment of the detector cause pressure variations in the detector internal space, which in turn causes temperature variations equal to the pressure variations in accordance with the equation of state. This causes the temperature of the fluid flowing into the detection cell to vary, which may result in the detector detecting the signal as noise.

In a liquid chromatograph that uses an organic solvent, the mobile phase is pressurized from several to around 100 MPa when pressurized and pumped through an analytical column, so that piping made of a metal material that has high mechanical strength and that is not easily corroded by organic solvents, such as stainless steel, is preferably used. Metal materials often have high thermal conductivity, and when the air pressure in the installation environment of the detector varies, the temperature of the fluid in the piping tends to vary sensitively or significantly. Variations in the temperature of the fluid in the piping cause noise in a chromatogram, which reduces the accuracy of automatic peak detection in chromatograms and causes discrepancies in measurement results, and thus it is desirable to reduce it.

FIG. 1A shows a case where detection output is on a normal baseline 101, and FIG. 1B shows a case where detection output is on an abnormal baseline 103 caused by noise 102. As shown in FIG. 1B, the noise 102 can reduce the accuracy of automatic peak detection and cause discrepancies in measurement results. In FIGS. 1A and 1B, the vertical axis represents detection output, and the horizontal axis represents elution time (min).

Japanese Unexamined Patent Publication No. 2022-119098 discloses a technique of promoting heat exchange with piping and ensuring temperature stability by embedding a wound part of piping of a liquid flowing into a detection cell in a casting. However, this technique cannot ensure temperature stability of the fluid in the detection cell because the temperature of the space around the piping from the wound part of the piping to the detection cell varies when the air pressure in the installation environment of the detector varies.

Japanese Utility Model Registration No. 3236505 describes a detection device for liquid chromatography that includes a thermally insulated housing having a UV detector housed in a thermally insulated cell on the upstream side and an RI detector housed in another thermally insulated cell on the downstream side. In the disclosed technology, the detection device for liquid chromatography controls a light source of the UV detector to be on or off and is equipped with a heat exchanger in the flow path connecting the UV detector and the RI detector, thereby ensuring constancy in the temperature of the RI detector in particular. However, the flow path from the heat exchanger to the RI detector is not directly thermally insulated. This technology is expected to be effective in reducing temperature variations caused by, for example, operation of an air conditioner that controls room temperature, but may be insufficient for reducing noise that occurs when the air pressure in the installation environment of the detector varies.

### SUMMARY

An object of the present disclosure is to provide a detector for liquid chromatography that reduces noise generated when the air pressure in the environment where the detector for liquid chromatography is installed varies.

A detector for liquid chromatography of the present disclosure includes a housing, a detection cell disposed inside the housing, an inlet pipe for introducing a fluid into the detection cell, an inlet-side heat exchanger disposed inside the housing and configured to exchange heat with a portion of the inlet pipe, and a filler disposed around a portion of the inlet pipe from the inlet-side heat exchanger to the detection cell, the portion being disposed inside the housing.

The detector for liquid chromatography of the present disclosure preferably further includes a differential refractive index detection section.

Preferably, in the detector for liquid chromatography of the present disclosure, a detector internal space covered with a thermal insulator is formed inside the housing; and the detection cell, the inlet-side heat exchanger, and the differential refractive index detection section are disposed in the detector internal space.

Preferably, in the detector for liquid chromatography of the present disclosure, the detection cell includes a sample cell and a reference cell; the inlet pipe includes a sample inlet pipe for introducing the fluid into the sample cell and a reference inlet pipe for introducing the fluid into the reference cell; and the filler includes a first filler disposed around a portion of the sample inlet pipe from the inlet-side heat exchanger to the sample cell, and a second filler disposed around a portion of the reference inlet pipe from the inlet-side heat exchanger to the reference cell, the portions being disposed in the detector internal space.

In the detector for liquid chromatography of the present disclosure, the fluid is preferably an organic solvent.

The detector for liquid chromatography of the present disclosure, in which the portion of the inlet pipe from the inlet-side heat exchanger to the detection cell in the internal space of the housing of the detector is embedded in a filling means, reduces noise generated in the detector when the air pressure in the environment where the detector is installed varies.

The detector for liquid chromatography of the present disclosure can reduces noise generated when the air pressure in the environment where the detector for liquid chromatography is installed varies.

### BRIEF DESCRIPTION OF DRAWINGS

FIG. 1A shows a normal baseline for the case where there is no noise in a chromatogram;

FIG. 1B shows an abnormal baseline for the case where there is noise in a chromatogram;

FIG. 2 is a conceptual diagram of a detector for liquid chromatography as a comparative example;

FIG. 3 is a conceptual diagram of a detector for liquid chromatography of the present disclosure;

FIG. 4 is a schematic diagram of a detector for liquid chromatography 400 of a first embodiment viewed from above;

FIG. 5 is a schematic diagram of a differential refractive index detection section 500 viewed from the side of the detector for liquid chromatography 400 shown in FIG. 4;

FIG. 6 shows an example of a calibration curve in SEC;

FIG. 7A shows an overall image in which chromatograms 701, 702, and 703 obtained under conditions 1, 2, and 3 are superimposed;

FIG. 7B is a magnified view of the baselines from 5.0 to 7.0 minutes of the chromatograms in FIG. 7A;

FIG. 7C is a magnified view of the peaks from 6.5 to 8.0 minutes in the chromatograms in FIG. 7A;

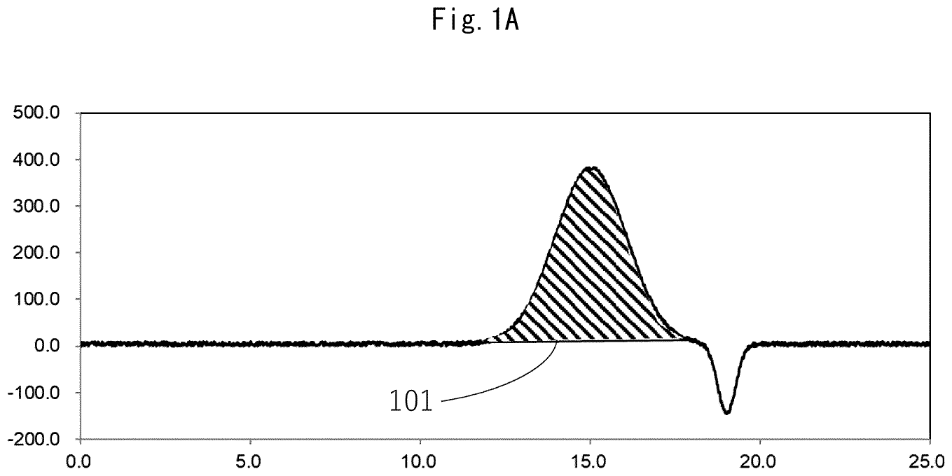

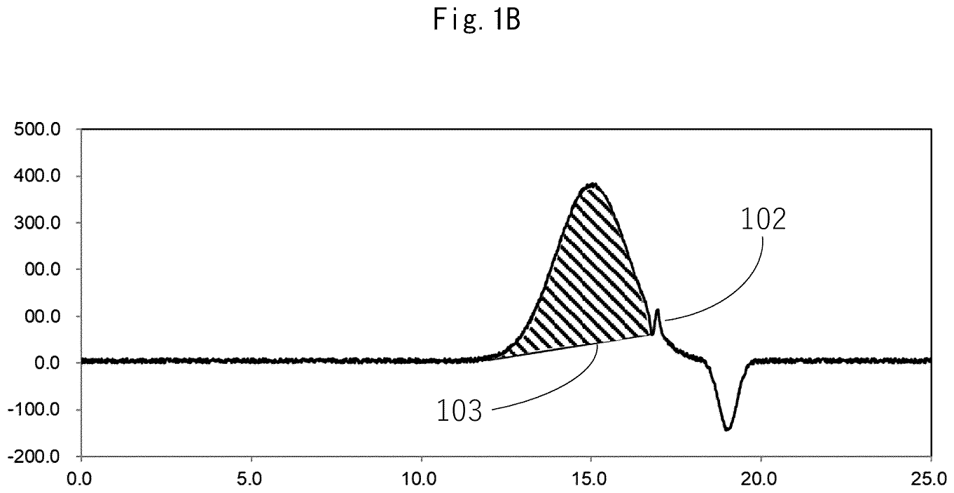

### DESCRIPTION OF EMBODIMENTS

A detector for liquid chromatography of an aspect of the present disclosure will now be described with reference to the drawings. However, note that the technical scope of the present disclosure is not limited to embodiments thereof, but extends to the disclosure described in the claims and their equivalents.

A detector for liquid chromatography of the present disclosure includes at least the following: a detection cell, an inlet pipe for introducing a fluid into the detection cell, an inlet-side heat exchanger that exchanges heat with a portion of the inlet pipe to stabilize the temperature of the fluid introduced into the detection cell, and a housing that houses the above components. That portion of the inlet pipe from the inlet-side heat exchanger to the detection cell which is exposed to the detector internal space is embedded in a filling means, so that the inlet pipe is not exposed to the detector internal space. This prevents heat transfer and heat transmission between the gas phase in the detector internal space and the inlet pipe, reducing noise in detector signals when the air pressure in the environment where the detector for liquid chromatography is installed varies.

Detection methods that can be used by the detector for liquid chromatography include ultraviolet-visible absorptiometric detection, diode array detection, fluorescence detection, differential refractive index detection, light scattering detection, electrical conductivity detection, and detection using an infrared spectrophotometer. A detector for liquid chromatography that can be used in the present disclosure only has to include at least the following: a detection cell, an inlet pipe for introducing a fluid into the detection cell, an inlet-side heat exchanger that exchanges heat with a portion of the inlet pipe to stabilize the temperature of the fluid introduced into the detection cell, and a housing that houses the above components. In short, there are no particular limitations on the type of detection method.

To reduce noise and drift in detector signals caused by temperature variations of the environment where the detector is installed, a detector for liquid chromatography generally uses a technique of reducing temperature variations in a detection cell and a block portion in which the detection cell is disposed by providing a housing insulation means and/or a housing temperature regulation means inside and/or outside a detector housing. The flow path of a detector for liquid chromatography includes at least the following: a detection cell and an inlet pipe for introducing a fluid into the detection cell. A detector for liquid chromatography generally includes an outlet pipe for discharging the fluid from the detection cell; an inlet-side heat exchanger that promotes heat exchange with the inlet pipe to increase temperature stability in the detection cell, thereby enhancing detection stability; and an outlet-side heat exchanger that promotes heat exchange with the outlet pipe to stabilize the back pressure of the detection cell, thereby enhancing detection stability.

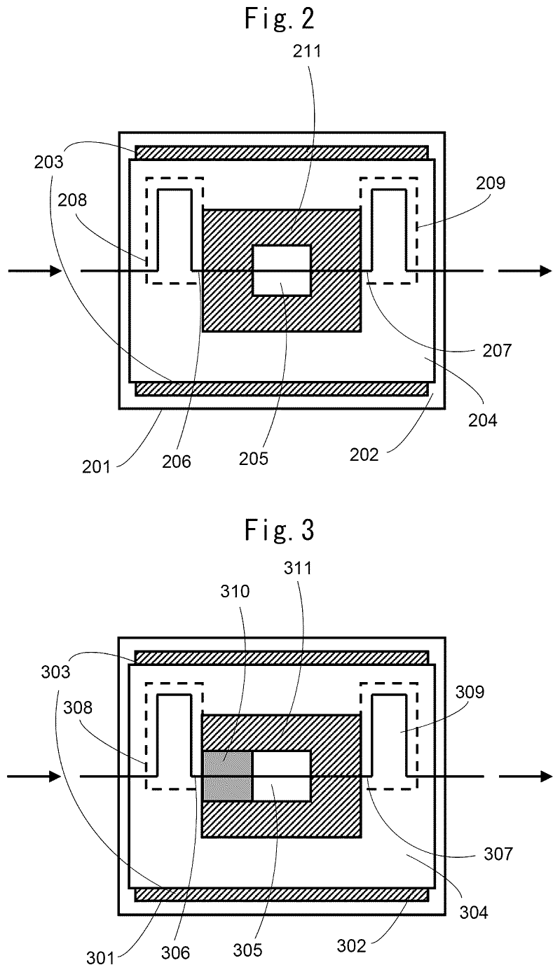

FIG. 2 is a conceptual diagram of a detector for liquid chromatography as a comparative example. As shown in FIG. 2, a housing insulator 202, a housing temperature regulator 203, a detector block 204, a detection cell 205, an inlet pipe 206, an outlet pipe 207, an inlet-side heat exchanger 208, and an outlet-side heat exchanger 209 are disposed inside a housing 201. It is difficult to place the inlet-side heat exchanger 208 and the detection cell 205 adjacent to each other without exposing the inlet pipe 206 to the detector internal space 211 at all because of assembly, working, and pipe connections in the manufacturing process of the detector for liquid chromatography.

FIG. 3 is a conceptual diagram of a detector for liquid chromatography of the present disclosure. As shown in FIG. 3, a housing insulator 302, a housing temperature regulator 303, a detector block 304, a detection cell 305, an inlet pipe 306, an outlet pipe 307, an inlet-side heat exchanger 308, and an outlet-side heat exchanger 309 are disposed inside a housing 301. Further, a pipe insulator 310 is disposed in the detector for liquid chromatography of the present disclosure.

Methods of connecting the inlet pipe for introducing a fluid into the detection cell to the detector cell include using pipe connection means, such as fittings, set screws, ferrules, and connectors, as well as welding, crimping, and adhesive bonding, but there are no particular limitations on the connection method. If a pipe is connected to the detection cell with a pipe connection means, it is preferable to embed the pipe and the pipe connection means in a filler. If the inlet pipe is embedded in a filler, the filler will inevitably be disposed around the inlet pipe, and the like. There are no particular limitations on the outer diameter, inner diameter, and material of the pipe that introduces a fluid into the detection cell. Suitable materials include metal materials such as stainless steel, plastic materials such as PTFE, PEEK, and PFA, and inorganic materials such as fused quartz.

Various fillers can be used for the pipe insulator 310 as long as they can reduce heat transfer and heat transmission from a detector internal space 311 to the pipe that introduces a fluid into the detection cell. There are no particular limitations on the shape, material, installation method, and fixing method of the filler. Examples of the shape include tubes, sheets, foam materials, and porous media. Examples of the material include fiber-based thermal insulators such as glass wool and rock wool, natural materials such as wool, polymer materials such as plastic, metal materials such as stainless steel and aluminum, and clay. The filler is preferably made of a material that is less likely to degrade over time, that emits less dust, or that is less likely to degrade or emit gas, even if an organic solvent used leaks.

A combination of multiple fillers may be used. For example, the pipe for introducing a fluid into the detection cell can be covered with a silicone tube, and the outside of the silicone tube can be further covered with polyurethane foam. If the outside of the silicone tube is further covered with polyurethane foam, an air layer is formed between the silicone tube and the polyurethane foam, enabling further reduction in heat transfer and heat transmission from the detector internal space to the pipe that introduces a fluid into the detection cell.

A detector for liquid chromatography generally includes an outlet pipe to discharge the fluid from the detection cell. Like the inlet pipe, it is difficult to place the outlet-side heat exchanger and the detection cell adjacent to each other without exposing the outlet pipe to the detector internal space at all because of assembly, working, and pipe connections in the manufacturing process of the detector. Even if the temperature of the fluid inside the outlet pipe varies when the air pressure in the environment where the detector for liquid chromatography is installed varies, the fluid will probably not flow back into the detection cell, and detector noise caused by variations in air pressure in the environment where the detector is installed will probably not be generated. However, when the inlet pipe is embedded in a filling means, the outlet pipe may also be embedded in the filler at the same time because the inlet pipe and the outlet pipe are routed in close proximity to each other near the detection cell. If the outlet pipe is embedded in a filler, the filler will unavoidably be disposed around the outlet pipe, and the like.

### First Embodiment

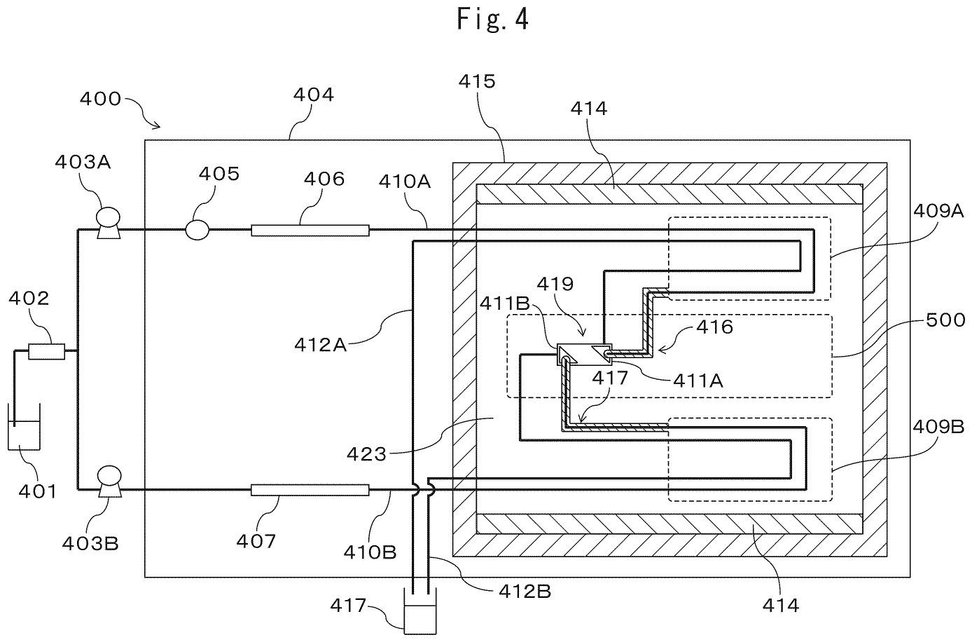

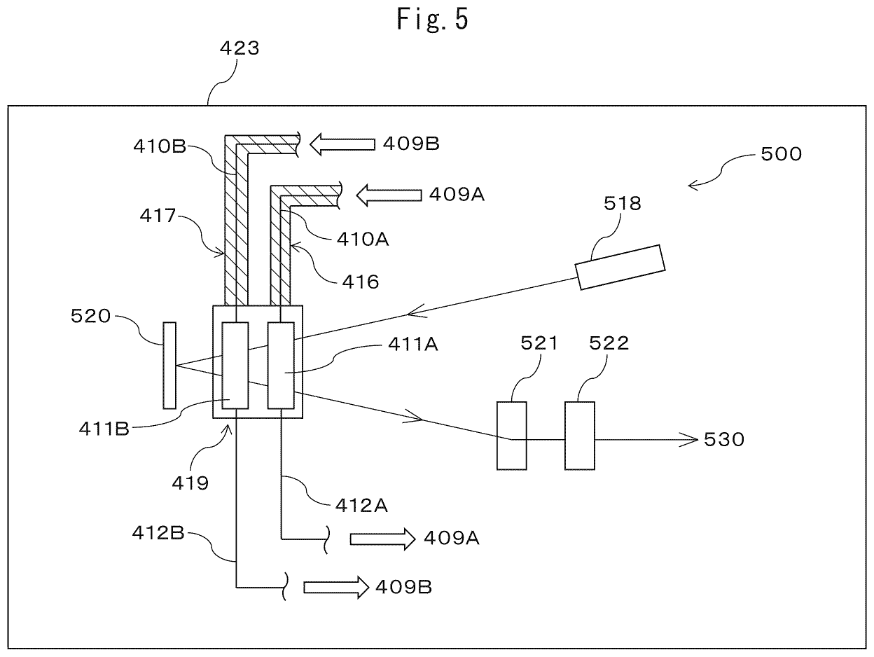

FIG. 4 is a schematic diagram of a detector for liquid chromatography 400 of a first embodiment viewed from above. FIG. 5 is a schematic diagram of a differential refractive index detection section 500 viewed from the side of the detector for liquid chromatography 400.

The detector for liquid chromatography 400 is a detector for performing size exclusion chromatography (hereinafter referred to as SEC) with a Bryce-type double-path, double-flow differential refractive index detection section 500. In the detector for liquid chromatography 400, a detection section compatible with another detection method may be used as described above, instead of the differential refractive index detection section 500.

As shown in FIG. 4, inside a housing 404, the detector for liquid chromatography 400 includes an injection valve 405, an analytical column 406, a reference column 407, a sample-side inlet pipe 410A, a sample-side outlet pipe 412A, a reference-side inlet pipe 410B, a reference-side outlet pipe 412B, and a housing insulator 415.

Inside the housing insulator 415 is disposed a housing temperature regulator 414 (e.g., a heater). In a detector internal space 423 formed inside the housing insulator 415 are disposed a detection cell 419, a sample-side heat exchanger 409A, a reference-side heat exchanger 409B, a portion of the sample-side inlet pipe 410A, a portion of the sample-side outlet pipe 412A, a portion of the reference-side inlet pipe 410B, a portion of the reference-side outlet pipe 412B, and the differential refractive index detection section 500. The sample-side temperature regulator 409A and the reference-side temperature regulator 409B are temperature-controlled by the housing temperature regulator 414. The housing temperature regulator 414 is covered with the housing insulator 415.

The detection cell 419 includes a triangular prism-shaped sample-side cell 411A and a triangular prism-shaped reference-side cell 411B. A filler 416 is disposed around the sample-side inlet pipe 410A disposed between the sample-side heat exchanger 409A and the detection cell 411A, and a filler 417 is disposed around the reference-side inlet pipe 410B disposed between the reference-side heat exchanger 409B and the detection cell 411B.

A mobile phase in a mobile phase container 401 passes through a deaerator 402 to remove dissolved gases, and is then sent by liquid delivery pumps 403A and 403B to the injection valve 405, the analytical column 406, and the reference column 407 installed inside the housing 404, and then introduced into the detection cell 419 disposed in the detector internal space 423. An eluate from the analytical column 406 is temperature-controlled by passing through the sample-side temperature regulator 409A, then passes through the sample-side inlet pipe 410A and is introduced into the sample-side cell 411A, passes through the sample-side outlet pipe 412A and is again temperature-controlled by passing through the sample-side temperature regulator 409A again, and is thereafter discharged into a waste liquid collector 417 outside the housing 404.

An eluate from the reference column 407 is temperature-controlled by passing through the reference-side temperature regulator 409B disposed in the detector internal space 423, then passes through the reference-side inlet pipe 410B and is introduced into the reference-side cell 411B, passes through the reference-side outlet pipe 412B and is again temperature-controlled by passing through the reference-side temperature regulator 409B again, and is thereafter discharged into the waste liquid collector 417 outside the housing 404.

As shown in FIG. 5, light emitted from a light source 518 passes through the detection cell 419, which is a combination of the sample-side cell 411A and the reference-side cell 411B, is reflected by a mirror 520, passes through the detection cell 419 again, and then passes through a zero-point correction mechanism 521 to a differential refractive index detection section 522, which detects the difference in refractive indices between the fluid in the sample-side cell 411A and the fluid in the reference-side cell 411B. The difference in refractive indices detected by the differential refractive index detection section 522 is transmitted to a control mechanism 530 (not shown in the figure).

The control mechanism 530 includes, for example, a processor, a memory (RAM, ROM, and storage devices), an input device (keyboard, mouse, touch panel, etc.), and a display, and controls the overall operation of the detector for liquid chromatography 400. The difference in refractive indices detected by the differential refractive index detection section 522 and transmitted to the control mechanism 530 is outputted as desired (displayed, printed, or transmitted to other devices and/or terminals) by the control mechanism 530 and made available to the user.

For the pipes from the liquid delivery pumps 403A and 403B onward (part of the sample-side inlet pipe 410A, part of the sample-side outlet pipe 412A, the reference-side inlet pipe 410B, and the reference-side outlet pipe 412B) can be used metal materials such as stainless steel, plastic materials such as PTFE, PEEK, and PFA, and inorganic materials such as fused quartz; but stainless steel material (JIS standard SUS316) is preferably used.

Various materials can be used as the fillers 416 and 417 as long as they can reduce heat transfer and heat transmission from the sample-side heat exchanger 409A and the reference-side heat exchanger 409B to the pipes that introduce a fluid into the detection cell 419. There are no particular limitations on the shape, material, installation method, and fixing method of the fillers 416 and 417. Examples of the shape include tubes, sheets, foam materials, and porous media. Materials that can be used include fiber-based thermal insulators such as glass wool and rock wool, natural materials such as wool, polymer materials such as plastic, metal materials such as stainless steel and aluminum, and clay. The fillers 416 and 417 are preferably made of a material that is less likely to degrade over time, that emits less dust, or that is less likely to degrade or emit gas even if an organic solvent used leaks. The same material or different materials can be used as the fillers 416 and 417.

A combination of multiple materials may be used as each of the fillers 416 and 417. For example, the pipe for introducing a fluid into the detection cell 419 can be covered with a silicone tube, and the outside of the silicone tube can be further covered with polyurethane foam. If the outside of the silicone tube is further covered with polyurethane foam, an air layer is formed between the silicone tube and the polyurethane foam, enabling further reduction in heat transfer and heat transmission from the detector internal space 423 to the pipe that introduces a fluid into the detection cell 419.

Differential refractive index detection is preferably used in SEC detectors to obtain the molecular weight distribution of a sample. Since an organic solvent may be used in SEC as a mobile phase, stainless steel piping that is not corroded by organic solvents is preferably used in a liquid chromatograph that performs SEC, and SEC is often performed in a local exhaust ventilation system or draft booth. For these reasons, in a detector for liquid chromatography including a differential refractive index detection section used in SEC, the stainless steel piping, which has high thermal conductivity, easily transmits temperature variations from the detector internal space to the mobile phase when the air pressure in the installation environment varies. This causes variations in the density of the mobile phase, which are easily detected as noise in a chromatogram.

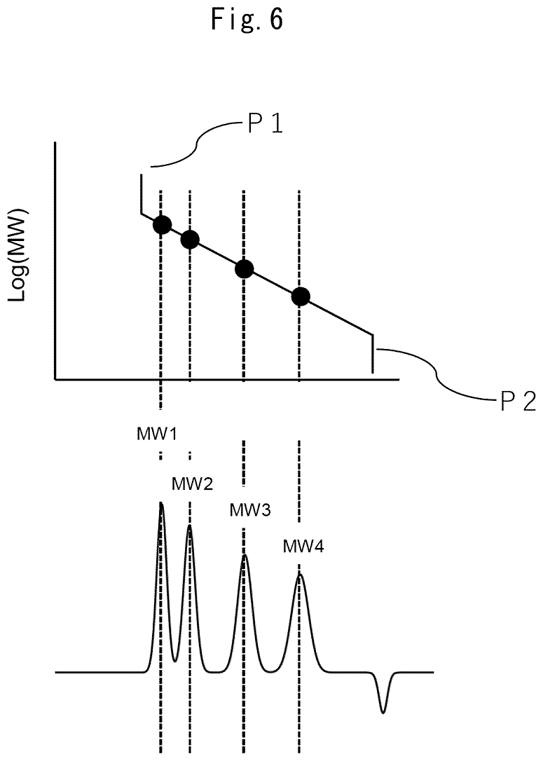

FIG. 6 shows an example of a calibration curve in SEC. In FIG. 6, the vertical axis represents the logarithm of molecular weight, and the horizontal axis represents elution time. P1 indicates the exclusion limit, and P2 indicates the permeation limit.

SEC is a technique for calculating the molecular weight distribution of an unknown sample with a calibration curve obtained by analyzing multiple standard samples of known molecular weight. In SEC, ideally, elution time and the logarithm of molecular weight have a linear relationship within a certain range. From the elution time of an unknown sample, the logarithm of the molecular weight is obtained using the calibration curve, and the molecular weight is obtained from this logarithm. As shown in FIG. 6, the horizontal axis of the calibration curve is elution time whereas the vertical axis is the logarithm of molecular weight. Thus, even a slight variation in elution time results in a large difference in the resulting molecular weight. More specifically, in SEC, noise generated when the air pressure in the installation environment varies can change the peak shape of a chromatogram and the peak top time, which is the elution time at the maximum output value of the peak, causing the calculated molecular weight distribution to be prone to variations. From these facts, it can be understood that the detector for liquid chromatography 400 has a particularly great advantage when it includes the differential refractive index detection section 500 for using differential refractive index detection. The following describes an experimental example in which the detector for liquid chromatography 400 shown in FIGS. 4 and 5 is used. In the experimental example, condition 1 is a chromatogram for the case where the air pressure in the installation environment varies when the fillers 416 and 417 are disposed around the sample-side inlet pipe 410A and the reference-side inlet pipe 410B in the detector for liquid chromatography 400. Condition 2 is a chromatogram for the case where the air pressure in the installation environment varies when the fillers 416 and 417 are removed from the detector for liquid chromatography 400. Condition 3 is a chromatogram for the case where the air pressure varies under conditions 1 and 2. As condition 3, a single example is given because the same results will be obtained when the air pressure does not vary under conditions 1 and 2.

When varying the air pressure in the installation environment, a SEC system with the detector for liquid chromatography 400 (HLC-8420GPC manufactured by Tosoh Corporation) was installed in a draft booth with an air pressure 150 Pa lower than atmospheric pressure, and the draft booth was temporarily opened to atmospheric pressure for 10 seconds each from 6.0 minutes and 7.0 minutes to vary the air pressure by 150 Pa.

The mobile phase used was tetrahydrofuran (THF) of high-performance liquid chromatography grade manufactured by Kishida Chemical Co., Ltd., and one TSKgel GMHHR-M (inner diameter 7.8 mm, length 30 cm) manufactured by Tosoh Corporation was used as the analytical column and the reference column each. The set flow rates of the liquid delivery pumps 403A and 403B were 1.000 mL/min and 0.250 mL/min, respectively. The sample used was a solution of TSKgel standard polystyrene of type F-1 (weight-average molecular weight Mw: 9490) manufactured by Tosoh Corporation dissolved in the above THE to a concentration of 1 g/L. The sample injection volume was 10 μL. A non-crosslinked highly foamed polyethylene sheet having a thickness of 1 mm was used as filler 416 and filler 417. Stainless steel material (JIS standard SUS316) was used for the pipes from the liquid delivery pumps 403A and 403B onward (part of the sample-side inlet pipe 410A, part of the sample-side outlet pipe 412A, the reference-side inlet pipe 410B, and the reference-side outlet pipe 412B).

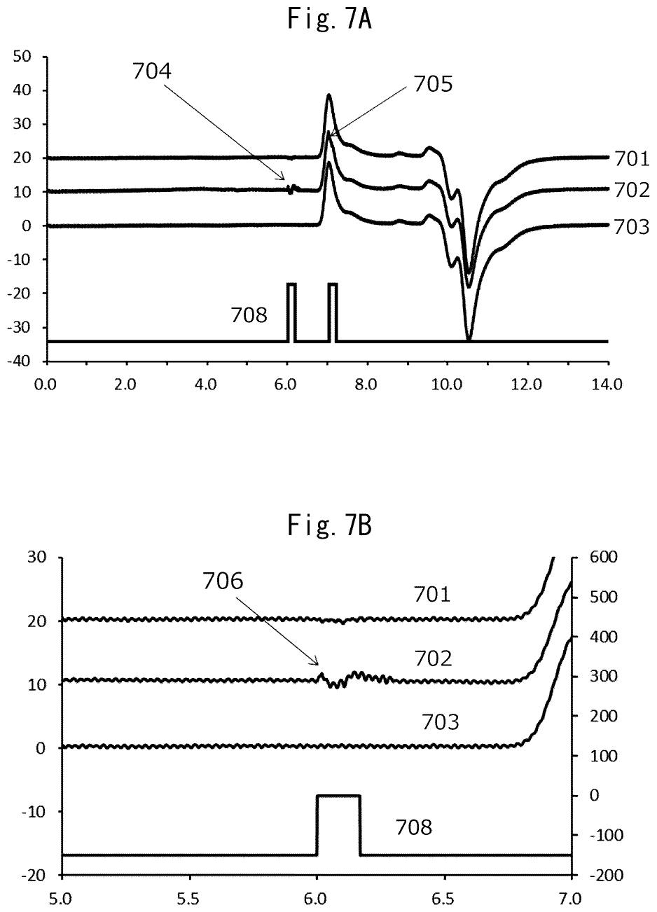

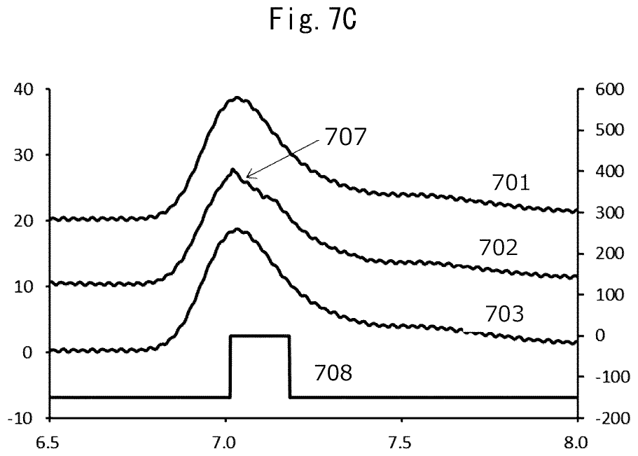

FIG. 7A shows an overall image in which chromatograms 701, 702, and 703 obtained under conditions 1, 2, and 3 are superimposed. The sample peak elutes at about 7 minutes, and the height of the output from the detector is about 18.88 mV. In FIG. 7A, 704 indicates first spike noise, and 705 indicates second spike noise. In FIGS. 7A and 7B, the horizontal axis is time from sample injection, which in SEC is equivalent to elution time. The vertical axis is detector output (mV). In FIGS. 7A, 7B, and 7C, 708 indicates pressure variations, and the vertical axis is the pressure difference (Pa) from the atmospheric pressure.

FIG. 7B is a magnified view of the baselines from 5.0 to 7.0 minutes of the chromatograms in FIG. 7A. It can be seen that under condition 2, spike noise 706 of a maximum of 1.12 mV occurs near 6.0.

FIG. 7C is a magnified view of the peaks from 6.5 to 8.0 minutes in the chromatograms in FIG. 7A. Under conditions 1 and 3, the elution time of the sample was 7.04 minutes, in which there was no difference. However, under condition 2, the elution time of the sample was 7.02 minutes, and spike noise 707 caused the peak top time to be earlier by 0.02 minutes. It was found that under condition 1, no shift in the peak top time of the sample was caused by noise. As a result, it was confirmed that disposing fillers 416 and 417 around the sample-side inlet pipe 410A and the reference-side inlet pipe 410B reduces noise generated in the detector for liquid chromatography 400 when the air pressure in the environment where the detector for liquid chromatography 400 is installed varies, and that this prevents the shift in the peak top time of a sample in SEC analysis and reduces noise on baselines.

It should be understood that those skilled in the art can make various changes, substitutions, and modifications to the disclosure without departing from the spirit and scope of the present disclosure.

1-5. (canceled)

6. A detector for liquid chromatography, comprising:
a housing;
a detection cell disposed inside the housing;
an inlet pipe for introducing a fluid into the detection cell;
an inlet-side heat exchanger disposed inside the housing and disposed with a portion of the inlet pipe; and
a filler disposed around a portion of the inlet pipe from the inlet-side heat exchanger to the detection cell, the portion being disposed inside the housing.

7. The detector for liquid chromatography according to claim 6, wherein the filler is disposed so that the inlet pipe from the inlet-side heat exchanger to the detection cell is not exposed to a detector internal space of the detector for liquid chromatography.

8. The detector for liquid chromatography according to claim 6, wherein the filler is made of tubes, sheets, form materials or porous media.

9. The detector for liquid chromatography according to claim 6, wherein the filler is made of glass wool, rock wool, wool, polymer materials, stainless steel, aluminum, or clay.

10. The detector for liquid chromatography according to claim 6, further comprising a differential refractive index detection section.

11. The detector for liquid chromatography according to claim 10, wherein a detector internal space covered with a thermal insulator is formed inside the housing, and
the detection cell, the inlet-side heat exchanger, and the differential refractive index detection section are disposed in the detector internal space.

12. The detector for liquid chromatography according to claim 11, wherein the detection cell includes a sample cell and a reference cell,
the inlet pipe includes a sample inlet pipe for introducing the fluid into the sample cell and a reference inlet pipe for introducing the fluid into the reference cell, and
the filler includes a first filler disposed around a portion of the sample inlet pipe from the inlet-side heat exchanger to the sample cell, and a second filler disposed around a portion of the reference inlet pipe from the inlet-side heat exchanger to the reference cell, the portions being disposed in the detector internal space.

13. The detector for liquid chromatography according to claim 6, wherein the fluid is an organic solvent.
